(19) United States
(12) Patent Application Publication
(10) Pub. No.: US 2008/0077415 A1
(43) Pub. Date: Mar. 27, 2008

(54) Method of customizing disposable consumer packaged goods

(76) Inventors: Thomas Gerard Shannon, Neenah, WI (US); Andrew Peter Bakken, Appleton, WI (US); Cynthia Watts Henderson, Neenah, WI (US); Jeffrey Dean Lindsay, Appleton, WI (US)

Correspondence Address: KIMBERLY-CLARK WORLDWIDE, INC.;Catherine E. Wolf, 401 NORTH LAKE STREET, NEENAH, WI, 54956, US

(21) Appl. No.: 11/514,036

(22) Filed: Aug. 31, 2006

(51) Int. Cl. G06Q 10/00

(52) U.S. Cl. 705/1

(57) ABSTRACT

Color-customized tissue cartons and products can be manufactured specially for consumers by providing consumers access to color coding systems at a retail store locations. Desired room decor colors, taken from paint chip colors or upholstery colors, can be matched at the retailer's location and the color coordinates stored in a database. Coordinating colors can be generated and all of the color information can be conveyed to a printer where tissue carton graphics are printed. As a result, the colors of the graphics can be customized to the consumer's specifications.

### BACKGROUND OF THE INVENTION

For many disposable consumer packaged goods such as facial tissues, there is increasingly less differentiation among various brands and products. In some cases, the technical capability to make products with improved properties has exceeded the market demand for improvement in those properties. Consequently, brands are faced with the challenge of differentiating themselves in other product aspects beyond the product in the package.

One approach to this challenge is to increase brand loyalty by building a more personal relationship between the consumer and the brand and its products by utilizing “mass customization” to modify certain aspects of the product specifically for that consumer. Some disposable consumer packaged goods, such as facial tissues and wet wipes, are contained within a package that stays clearly visible within the home environment, allowing the package to become a part of the overall room decor. As a result, the overall fit of the packaging to room decor can become an integral part of the consumer's selection of a particular brand of product. In some cases the packaging is more important in the consumer's selection of the tissue product than the specific attributes of the tissue itself.

To assist in satisfying as many consumers as possible, the solution to date has been to make the product available in a variety of package formats, colors and designs. While this does help resolve the problem to some extent, it is still not possible to match the needs of all consumers, even when offering a wide variety of packages. In addition, offering a wide variety of packages increases the number of products on the retailer's shelf and requires a large amount of shelf space in order to make satisfactory inventory levels of each product available to the shopper. Thus, in general, the number of offerings available to the consumer from any one brand is generally quite limited.

In addition, traditional retail outlets or distribution channels, such as grocery and drug stores, are not always aligned with the purchase of items related to a consumer's home decor. While mass merchant stores may have both home decor offerings and facial tissue, for example, within the same store, the physical distance between them within the store makes connecting the decor of the facial tissue or other consumable good problematic. For example, bathroom decor items such as shower curtains, toothbrush holders and soap dispensers are typically merchandised together so that the consumer can coordinate his/her selections. However, facial tissue, which one may also desire to coordinate with the bathroom, is merchandised elsewhere. While hardware or home improvement stores also cater to home decor purchases, such as paint, these outlets do not usually offer disposable consumer goods.

Consequently there is a need to provide the consumer with a wide variety of packages that mitigates the aforementioned problems and is convenient for the consumer. There is a further need to increase the involvement of consumers in the purchase of disposable consumer packaged goods, such as facial tissue, in a manner that does not involve the appearance of additional work on the part of the consumer relative to the purchase of the consumer packaged good. There is a further need to provide a means for establishing a relationship between a consumable packaged good, such as facial tissue, and home decor whereby the consumer is compelled to purchase such items outside of more traditional retail distribution channels or within the current retail setting but outside the location where such products have been traditionally located, such as the paper aisle. Such separation of the product from the traditional retail space provides additional evidence of product differentiation to the consumer. While providing a wide variety of packages is essential, it is desirable to not burden the consumer with a lengthy or complicated process, yet instill in the consumer the confidence that their choices are appropriate for their decor.

### SUMMARY OF THE INVENTION

It has now been discovered that providing customized designs on consumer packaged goods, particularly facial tissue packages, can be accomplished by involving certain retailers and their capabilities to characterize or identify colors. The method involves using various combinations of the following elements: (a) networked computer databases; (b) standardized color coding systems that enable an almost unlimited selection of colors; (c) retailer systems for color matching paints; (d) retailer data bases containing color codes for various product offerings; (e) on-line computer access (internet) with security; (e computer software algorithms that allow conversion of spectrophotometrically measured color coordinates to suitable parameters for printing; and (g) computer programs capable of identifying complementary colors and preparing series of designs and color schemes using complementary color models. Convenience is enhanced by allowing the consumer to stop at any level in the customization process and allow the computer to generate selections at that point in time. The method can also be extended to basic product selection and/or customization of functional product benefits as well as packaging. For example, in the case of facial tissue, the customization may include allowing the consumer to choose from a selection of basesheet physical properties such as 1-ply, 2-ply, 3-ply, high strength, high softness, etc. Additional options may be provided for customization such as addition of lotion, anti-viral or anti-bacterial agents, particular scents or other functional benefits and additives.

In general, the invention resides in a method for enhancing the relationship between a consumer and a disposable consumer packaged good by creating a relationship between the disposable consumer packaged good and a durable consumer good or service through customization of the package containing the disposable consumer packaged good at time of purchase of the durable good or service such that the disposable consumer packaged good is coordinated with the durable consumer good or service.

More specifically, the invention resides in a method of making color-customized packages for disposable consumer packaged goods using a networked computer database shared by a package manufacturer and one or more retailers and which is optionally accessible by individual consumers, the method comprising: (a) providing a consumer access to a color coding system at a retail location that can identify the color coordinates of a designated color or colors to be matched; (b) identifying the color coordinates of the designated color or colors and storing their identities in the computer database; (c) optionally, generating and/or identifying complementary and/or contrasting colors and storing their color coordinates in the computer database; (d) providing the consumer with options for graphic designs to be printed on the package, such as by providing visual images, and enabling the consumer to select a design; (e) applying the identified colors to the selected design and storing the resulting colored design information in the database; (f) accessing the colored design information by the package manufacturer; and (g) printing a package with the colored design and producing a customized disposable consumer packaged good with a package containing the colored design.

For purposes herein, a retailer can be any retail store that sells goods to the public, particularly including paint stores, home furnishing stores, automobile dealers, mass merchandisers (such as Wal-Mart or Target), home improvement stores (such as Home Depot or Lowes) and the like. Stores which sell paint are particularly suited for purposes of this invention because they already have the capability to match colors from paint chips or other color samples. Advantageously, the method can be carried out in conjunction with a purchase activity requiring higher involvement on the part of the consumer, such as home decorating or the purchase of an automobile or automobile service.

As used herein, a disposable consumer packaged good is defined as a product comprising a package and multiple product specimens wherein the said product specimens are contained within the package and are primarily intended to be used once, then disposed. The packaged good may or may not contain discrete individual specimens within the package but the package must be capable of enabling dispensing of discrete amounts of material. Examples of disposable consumer packaged goods include, but are not limited to, facial tissue, bath tissue, paper towels, wet wipes, liquid soap, feminine care pads, cotton swabs, toothpaste and other such oral care products, disposable diapers and the like. The package may be constructed of any material typically used for packaging disposable consumer goods including paperboard carton, poly bag, poly wrapping, etc, that contains the product specimens and provides a dispensing means for accessing said product specimens. A key feature of the disposable consumer packaged goods of the present invention is that, while both the package and product specimens contained within the package are intended to be disposed of upon use, the package containing the discrete product specimens is intended to last for an extended period of time relative to the life of the discrete product specimen. In a specific embodiment the package containing the discrete product specimens is intended to be disposed only after the all the individual product specimens within the package have been used or disposed. In a sense the package becomes a semi-durable item and thus capable of becoming an integral part of the overall aesthetics of a durable good or service. A particularly relevant consumer packaged good of the present invention is facial tissue.

As used herein, a durable consumer good or service is defined as a product or output of a service that is intended to be used multiple times or for an extended period of time prior to disposal or complete consumption. Examples of durable goods include, but are not limited to, automobiles, television and entertainment devices, home appliances, housing, carpeting, paint, draperies, furniture, bathroom fixtures, shower curtains, kitchen cabinets, bathroom cabinets, wall paper, upholstery, linens, cloth towels, bed sheets, decorated waste baskets, clothes hampers, toothbrush holders and the like. Durable consumer services include, but are not limited to, such things as interior design and decoration, landscape design, home maintenance, automobile maintenance and the like.

Another advantage of the present invention is the ability to influence placement of the disposable consumer packaged good within a room such that the product is used more frequently than if the product were located in a drawer or closet of the room. This is particularly important with products whose success relies on a change on the part of the consumer. An example is perineal moist wipes. Such products may be located in a drawer or elsewhere in the room such that it is hidden from sight. Since for most consumers such products are still not a part of their routine perineal care, there is nothing special to attract the consumer to the product or to restock the product once the product is depleted in the bathroom. The package customization process of the present invention, when applied to such products, has the ability to increase the involvement of the consumer with these products and thus increase the probability that these products will be used more often in the consumer's home.

### DETAILED DESCRIPTION OF THE INVENTION

A particularly suitable disposable consumer packaged good for illustrating the method of this invention is facial tissue, where individual tissue specimens are dispensed from a package, which is commonly a carton. While the following description is directed to facial tissue cartons, it will be appreciated the same methods can be applied to any consumer packaged good or package.

For tissue carton design, the process starts with the consumer identifying a color or colors to match. This color or colors could be from a paint chip, a fabric swatch, etc. which may be provided by the consumer or someone other than the consumer, such as the retailer. Typically, the consumer may bring an item into the retail store for the color to be matched. Alternatively, the color could be selected at the point of purchase of the particular good to be matched. Such goods may include, but are not limited to, such things as draperies, wallpaper, paint, floor coverings, linens, upholstered furniture or any other such durable item typically associated with home decor. Color matching can be done by any colorimetric method known in the art, such as the CIE L*a*b system or equivalent. Typically these systems measure color spectrophotometrically. However, in some cases the color coordinates may be pre-associated with the item purchased and may not need to be separately measured. For example, when selecting a paint color from a series of paint chips, the color coordinates of a particular chip are already determined and do not need to be measured. Upholstery fabrics and similar products also typically have associated colors that are formulated such that exact color coordinates for individual colors are known or can be determined without spectral measurement.

Any suitable color model can be used to characterize the matching color. For example, “CMYK”, which is the shortened name for Cyan-Magenta-Yellow-Black, is a color model in which all colors are described as a mixture of these four process colors. CMYK is the standard color model used in offset printing for full-color documents. Using this model to print full-color photos with an offset printing press, one must first separate the photo into the four basic ink colors. Each color is then printed separately in layers, one on top of the other, to give the impression of infinite colors. Since such printing is based on the use of inks of these four basic colors, it is often called four-color printing. CMYK is also a standard used for many digital printing processes.

Another color model, “RGB”, can also be used to characterize the matching color. RGB is a Red-Green-Blue color model used typically for electronic display devices such as television, video and computer screens. For purposes of this invention, RGB would be the most convenient color system to be used when displaying the chosen colored carton or other package design to the consumer on the screen of the display device for their approval. RGB colors can be be converted into CMYK colors for printing so that the printed carton looks the same as what appears on the display screen. Conversely, CMYK colors can be converted to RGB colors for display purposes if the initial matching color coordinates are stored as CMYK colors. The use of known algorithms to convert color coordinates to RGB equivalents for display on a monitor is described in U.S. Pat. No. 6,914,613 B2. Similarly, conversion to CMYK coordinates for printing onto films or other packaging substrates is described in US2005/0264865 A1. Both of these references are hereby incorporated by reference. A variety of algorithms and associated software programs are known in the art for accomplishing these transformations.

As mentioned above, in one embodiment of the invention the color selection can be based on colors in draperies, linens, upholstery and the like. For situations in which selected retailers have collaborated with the tissue carton manufacturer, when the consumer purchases a sofa, chair, draperies, bed linens, etc., the data for the various colors and/or designs selected by the consumer could be sent by the retailer to the main server and accessed by the carton manufacturer so that tissue cartons could be made to coordinate with the colors and/or designs of the purchased items. Various potential carton designs could be uploaded as digital images at the retailer's location for the consumer to review and select. Alternatively, the retailer and the carton manufacturer can prearrange to have all of the color and graphics options in the database, so the consumer could simply enter the product code to get desired graphics and matching colors. This could be done at the retailer location or from the consumer's home computer, for example.

In another specific embodiment, the tissue carton could be coordinated with a paint color selected for painting a room within the consumer's home. The consumer would enter the retailer's store and select a paint color or colors based on a series of paint chips provided by the retailer. Alternatively, the consumer may bring an object from the room to be painted and have a specific color or colors in that object matched by any of the commonly available commercial color matching devices widely used and readily available to retailers.

The color coordinates of the matching color or colors can be stored in a unique file identified by the consumer's name or other selected identification. Other specific identifiers may be applied to the colors. For example, where one or more colors are used, such things as identification of the base color and auxiliary or highlight colors may be identified. In addition, the file may have inputted and contain additional information regarding any specific patterns or designs unique to the decor of the room such as stencil patterns, wall paper borders, specific designs related to draperies, furniture etc. which may be located in the room. The consumer's name and address can provide a reasonable first level of file identification, for example. A second level of identification may include a specific room within the house to which the color/design is to be assigned. The color coordinates and any additional information relative to the customization can be directly sent electronically from the retail store to a server. The server may be centralized such that it is accessible via multiple servers owned by entities such as, but not limited to, the retailer, the carton manufacturer, the tissue manufacturer, contract manufacturers, etc. A consumer could then either access the server through the retail store or from home to continue the customization process.

Once the matching color coordinates are identified, any of a number of tools or computer color programs can be used to optionally generate complementary and/or contrasting colors. Early examples include the color wheels developed by Tobias Mayer (1758), Johann Goethe (1810) and M. E. Chevreul (1864). More recently, Johannes Itten and Bill Murphy have devised color guide wheels of their own. Color wheels are also available in software form. An example of such a software tool is the Color Wheel PrO® from QSX Software group and Color Schemer Studio by Color Schemer at www.colorschemer.com. Such software packages allow for easy determination of complementary and contrasting colors. Multiple color coordinates can be identified and stored in the file for any room.

In selecting a graphic design for the tissue carton, the consumer has a variety of options. For example, the consumer can select from a variety of themes and graphic designs already entered into the computer database, either by various participating retailers or the tissue carton manufacturer. In certain situations, the number and type of designs may be limited to certain retailers. Thus, certain retailers may have unique designs available only through their outlets, thus providing a point of differentiation from other retailers. While limitations on specific design schemes may be limited to a given retailer, the number of color offerings is not limited. Alternatively, the consumer may input their own designs, including pictures. This is in effect similar to a clip art system. Various elements of the design can then be colored based on the matching or contrasting/complementary colors. In a particular embodiment, the computer server generates a series of options for the consumer once a theme is selected. Possible themes include, but are not limited to, sports, nature, cars, floral, geographic, geometric designs, seasonal, etc. In some cases, certain portions of the image may be a set color and not changeable by the user. For example, in a nature theme, limitations may be built into the design such that trees are green and the sky is blue. On the other hand, flowers, birds or other objects could be custom colored as desired. As with clip art, themes could be searched by the consumer using keywords to narrow down their choices. In a specific embodiment, the design choices could be presented to the consumer as multiple thumbnails or as a slide show-type presentation. For any given design image selected, the consumer could make the color selections or could have the option to have the computer suggest color combinations. Once a specific design and color combination is selected, the selection can be saved in the database, such as by using the field “room” as the key selector. The consumer has the option to create and store multiple theme/color combinations for any room. The option also exists to design for multiple rooms.

In one embodiment, the customized package can be branded with the brand of the manufacturer of the tissue. In a specific embodiment, the customized tissue product is co-branded wherein both the brand name of the tissue manufacturer and the brand name of the retailer or other entity associated with the customization, such as make or model of automobile, will appear on the package. The co-branding of the tissue product with the other entity, such as the retailer or car manufacturer or car dealership, helps to establish the link in the consumer's mind between the two entities, thus helping expand the distribution channels for the product.

Once a consumer has selected their designs, the designs and color combinations can be stored in a file on the server for future access and ordering by the consumer. A consumer may have one or several designs selected. When ordering or re-ordering, the consumer will log into the system using their unique identifying code (such as name and address) and password. Selection to order can be made by a simple point and click routine. Product specifications (which include information on product type, size, etc.), carton specifications (which include the type of carton and the specific custom design) and shipping and billing information are sent from the main server to the manufacturing location. This is done by one click by the consumer when they select the “order” button. Once the first order is placed, the consumer does not need to input any information unless the order is changed from the previous order. A simple point and click generates a duplicate of the previous order.

In addition to selecting the carton design, the consumer may also have the option to select the type of tissue to fill the carton depending on the number of tissue basesheet choices available from the particular tissue manufacturer. For example, some basesheets may be lotion-treated, some may be silicone-treated, some may contain a virucide, some may contain a fragrance and some may be plain. Pricing of the product may vary accordingly. Available options may include product type, style and size of the carton as well as the number of tissues contained within the carton. For example, facial tissue may be supplied in an upright, flat, oval or pocket pack of varying sheet count formats. Multiple formats may be available for the consumer to select or they may be restricted to a single or limited number of formats. Shipping and billing information and custom design specifications can be fed from the master server to the manufacturing location. For each type of product, tissue clips to fill the cartons may be available or, if the production facilities are present within the site, the tissue clips may also be made to order at the time the order is received. As a practical matter, it is most likely that the tissue clips would be pre-manufactured and sent to the packaging site, which may be within the same mill or may be a third party custom printing and converting facility. If a fragrance is included in the order, the fragrance could be added to the carton at some point in the process after carton selection, the specific point not being overly critical. As relatively low volumes of fragrance are required, a large selection of fragrances could be available for selection by the consumer.

Specific supply chain strategies for production and delivery of the customized tissue product can be carried out in any suitable manner as long as consumer expectations for delivery, service and quality are met. Actual production of the product may be done via any method known in the tissue making art. Printing of the carton may be done via any method known in the art including, but not limited to, flexographic and digital printing. In a particular embodiment, the designs and colors can be digitally printed onto the carton, which allows for more flexibility in design offerings. The custom printing may be done directly on the carton package or may be printed separately on an adhesive label or shrink sleeve as described in co-pending, commonly-assigned U.S. provisional application Ser. No. 60/813477, herein incorporated by reference.

In situations where the customized tissue product is associated with a durable good or service, it is desirable that the customized tissue product be available to the consumer during the duration that the consumer possesses the durable good or result of the durable service. Thus the consumer of the durable consumer good or service can be assured of a supply of the coordinated tissue products over the span of time in which the consumer owns or possesses the durable good or the product of the durable service. Such a means is provided in one embodiment by the digital data information located on the server in conjunction with the ordering/reordering process defined hereinafter. Certain aspects of the reordering process mitigate the need of the retailer to provide an on-going supply of the customized product on the retail shelves.

Placing orders for the customized products can be carried out in various ways. When a retailer is used, the retailer may be integrally incorporated in the product reordering process to maintain links between retailer, manufacturer and consumer. For example, the consumer may order or reorder their customized tissue from home via the internet or through the retailer's web site. The order can be delivered to the retailer or shipped directly to the consumer's home. Such a method maintains a link between the consumer and the retailer beyond the initial purchase and selection process. Co-branding, if present, would continue on the reordered packages as with the packages received during initial ordering. Alternatively, the customized tissue product can be ordered or reordered at home by the consumer through the tissue manufacturer's website. The customized tissue product is then shipped to the retailer where the product is picked up by the consumer at the retailer. Such a system has an advantage in maintaining a relationship between the consumer, retailer and the tissue product manufacturer. Alternatively, the tissue product can be ordered or reordered at the retailer's location and shipped directly to either the consumer's house or to the retailer for later pick-up by the consumer.

In the simplest embodiment for ordering or reordering, the consumer logs on to the appropriate site, enters their personal ID number such as name and address and specific room for the product. The room selection may appear as a dropdown menu or other method of showing predetermined choices. The consumer may be prompted for a password for additional security. A visual representation of the product may be presented to the consumer to insure correctness. The consumer then enters the quantity of the product to be purchased and then clicks “order” to have the product purchased.

Billing may be done automatically and need not require entering of a credit card number or other information. Such systems are well known in the art and are used commercially. One will recognize that such a system could be done either at the consumer's personal computer at home or at a location within the retailer environment. Other payment options may be utilized to address specific consumer concerns regarding on-line security when paying for goods online. In one embodiment, the tissue product is reordered in the retail location. After selecting the correct products, the consumer is prompted to pay either with cash or credit at the point of selection. Such a system could resemble standard self-checkout systems widely available today in traditional retail outlets and grocery stores. In another embodiment, an account-based system such as PayPal may be used. Such account based systems are typically found when using personal computer systems, however, they could be used within the retail setting as well. The account-based system allows anyone with an e-mail address to securely send and receive on-line payments using their credit card or bank account. The account-based system offers a secure service through which funds can be transferred from one account to another.

### EXAMPLES

### Example 1

(Coordinating the tissue package, in this example a carton, with home decor.) For this example, a home improvement retailer, such as Home Depot, is utilized to allow a coordinated tissue package to automatically be selected or suggested as an option when a consumer shops for home fixtures, carpets, paints, or other item related to home decorating or similar home improvement activity. For example, when the consumer approaches the paint or other service desk at the home improvement retailer to initiate an activity such as a paint match or other discussion related to the home improvement activity, the consumer at some point in the discussion may be asked about interest in a coordinated disposable consumer packaged good, such as facial tissue. In a specific embodiment, the third party and the consumer are integrally involved in the design of a room. For example, in one embodiment the room design consists of a paint and a wall-paper border or alternatively to the wall paper border, a stenciled design. The stenciled design will consist of a repeat pattern divided into specific parts with each specific part being painted a given color. The repeat pattern is then applied around the perimeter of the room after the walls of the room have been painted. The stenciled design will typically run around the perimeter of the room similar to the wall paper border. A wall-paper border is a strip of wall paper, typically less than 18″ in diameter that extends around the perimeter of the room typically near the top or middle of the walls. The paint scheme may consist of one or more colors.

When more than one color is used for the walls of the room, the walls may be decorated with one or more techniques widely used for decorating including, but not limited to, such techniques as sponging, rag-rolling, stippling and paneling. Such techniques provide unique designs of non-repeat random patterns to the walls. Such designs can be modeled or reproduced by computer programs. The color coordinates for the color or colors used to paint the walls are input into the program and optionally the specific decorating technique used. The colors are input such that the base color and auxiliary colors are used. In many of the decorating techniques listed above, a base color is applied to the entire wall surface. Then the auxiliary colors are applied via the methodology of the specific technique. The result is that the base color will cover the entire surface of the wall while the auxiliary colors cover less of the surface area giving the desired effect. The program generates a pattern that will approximate the match on the consumer's walls according to the specific decorating technique selected. As most of the decorating techniques described provide a random pattern, an exact match is not needed. A digital image of the border selected is then applied to the design. The border will be located on the image near the location where the border will be placed in the room. For example, if the border is applied near the top of the room, the border will be located on the image near the top of the image. Top here refers to the vertical side of the panel and not the top horizontal plane of the carton. The result is a carton which will be a near match with the wall design. If a stenciled border is used, the color coordinates associated with each specific part of the individual repeat pattern can be input into the program. An actual representation of the stenciled border can then be graphically displayed and printed as part of the overall image.

The border image on the carton is preferably larger than the scale present in the room. For example, an 8 inches border applied to a standard 96 inches tall room wall will have a scale of 1:12. When applied to a tissue carton of a height of 4 inches, the border would have a height of 0.33 inch. Such a small height could cause loss of image definition. As such the border is preferably from about 1.5-6 times the scale of the actual border in the room. Preferably the border will have a width of from about 0.5 inch to about 2 inches in height.

All of this information is inputted by the retailer at the time of purchase of the room decorating supplies. The coordination of the tissue carton with the room decorating is presented in such a way as to be viewed as a service provided by the retailer. Very little involvement is needed by the consumer in this process. Such service may be provided free of charge or a fee may be applied as part of the overall decorating package products and services. Alternatively, the information can be input by an interior decorating service provider.

### Example 2

(Coordinating the tissue carton with the upholstery or exterior of the consumer's automobile). For this example, the specific color and design information is provided by the vehicle manufacturer for specific vehicle models. This information could either be input by the shopper or could be generated by interaction of the tissue manufacturer server with the databases from the auto manufacturers. For example, in one embodiment a consumer may simply enter the VIN number of their vehicle into the customized product database. The server would then connect to the server of the auto manufacturer to automatically determine the colors (interior/exterior) of the vehicle. The vehicle information can then be associated permanently to the consumer such that when re-ordering, only the word “AUTO1” or something similar would need to be selected. The carton could be coordinated with the interior color, exterior color or combination of interior and exterior colors. In a specific embodiment, the carton is printed with an image of the car in the color of the car on a background that matches the interior color and design. In a specific embodiment the carton is cylindrical or otherwise shaped or adjusted so as to fit in a cup holder within the car.

In a particular embodiment, the reordering and delivery of the product is done through the automobile dealership. Such a method may preferably involve an exclusive relationship between the auto company or dealership and the tissue manufacturer such that the auto dealership has a competitive advantage in marketing its services over non-manufacturer service providers. In a particular embodiment, the consumer takes his/her vehicle to be serviced according to the regularly scheduled maintenance for the vehicle. Such maintenance may include, but is not limited to such things as oil changes, tire rotation, coolant service, periodic mileage checks, etc. The VIN and service history of the vehicle are stored in the dealership's or service provider's database. This allows for an immediate connection to the color and design options of the car and enables the product to be available to the consumer at time of purchase of the service. The owner of the vehicle may be asked at the time of service if they would like the tissue product or the product may be given gratis. The product may be immediately available for purchase or may be sent directly to the consumer's house. In a preferred embodiment, the item is available at the time of purchase of the auto service. In another embodiment the item is given to the consumer at the time of purchase of the service free of charge with ability to order more. The tissue product may be co-branded with both the automobile manufacturer's name and the tissue product name.

It will be appreciated that the foregoing description and examples, given for purposes of illustration, are not to be construed as limiting the scope of the invention, which is defined by the following claims and all equivalents thereto.

We claim:

1. A method of making color-customized packages for disposable consumer packaged goods using a networked computer database shared by a package manufacturer and one or more retailers, the method comprising:
(a) providing a consumer access to a color coding system at a retail location that can identify the color coordinates of a designated color or colors to be matched;
(b) identifying the color coordinates of the designated color or colors and storing their identities in the computer database;
(c) providing the consumer with options for graphic designs to be printed on the package and enabling the consumer to select a design;
(d) applying the identified colors to the selected design and storing the resulting colored design information in the database;
(e) accessing the colored design information by the package manufacturer; and
(f) printing a package with the colored design and producing a customized disposable consumer packaged good with a package containing the colored design.

2. The method of claim 1 further comprising generating and/or identifying complementary and/or contrasting colors and storing their color coordinates in the computer database.

3. The method of claim 1 wherein the consumer is provided with visual images for the graphic design options.

4. The method of claim 1 wherein the identified color coordinates are stored in the computer database in a file associated with the consumer.

5. The method of claim 1 wherein the colored design is stored in the database in CMYK coordinates.

6. The method of claim 1 wherein the consumer places an order for the customized disposable consumer packaged good over the internet from the consumer's computer.

7. The method of claim 1 wherein the consumer places an order for the customized disposable consumer packaged good over the internet from the consumer's computer and the customized disposable consumer packaged good is manufactured and shipped to the consumer.

8. The method of claim 1 wherein the consumer places an order for the customized disposable consumer packaged good over the internet from the consumer's computer and the customized disposable consumer packaged good is manufactured and shipped to the retailer for pick-up by the consumer.

9. The method of claim 1 wherein the consumer places an order for the customized disposable consumer packaged good from the retailer's computer.

10. The method of claim 1 wherein the consumer places an order for the customized disposable consumer packaged good from the retailer's computer and the customized disposable consumer packaged good is manufactured and shipped to the consumer.

11. The method of claim 1 wherein the consumer places an order for the customized disposable consumer packaged good over the internet from the retailer's computer and the customized disposable consumer packaged good is manufactured and shipped to the retailer for pick-up by the consumer.

12. The method of claim 1 wherein the designated color to be matched is a paint color.

13. The method of claim 1 wherein the designated color to be matched is from a fabric.

14. The method of claim 1 wherein the retailer is a paint store or a home improvement store.

15. The method of claim 1 wherein the retailer is a mass merchandiser.

16. The method of claim 1 wherein the retailer is a home furnishing store.

17. The method of claim 1 wherein the retailer is an automobile dealership.

18. The method of claim 1 wherein the retailer is a fabric store.

19. The method of claim 1 wherein the disposable consumer packaged good is a facial tissue product.

20. The method of claim 19 comprising providing the consumer with options for the type of tissue sheets to be placed within the tissue package and storing the selected product in the consumer's file.

21. The method of claim 19 comprising providing the consumer with options for the type of scent to be selected for the tissue and storing the selected scent in the consumer's file.

22. The method of claim 1 wherein the disposable consumer packaged good is a wet wipe product.

23. The method of claim 1 wherein the disposable consumer packaged good is a liquid hand soap product.

24. The method of claim 1 wherein the color-customized package is matched to a durable consumer good related to home decor.

25. The method of claim 24 wherein the package comprises a graphic design element related to a wallpaper border or a stenciled design.

26. The method of claim 24 wherein the package comprises a graphic design element related to a wall decorating technique.

27. The method of claim 26 wherein the wall decorating technique is selected from the group consisting of sponging, rag rolling, stippling or paneling.
